(19) United States
(12) Patent Application Publication
(10) Pub. No.: US 2010/0064036 A1
(43) Pub. Date: Mar. 11, 2010

(54) PERIPHERAL DEVICE OPERATION METHOD, PERIPHERAL DEVICE AND HOST

(75) Inventors: Jilin Li, Shenzhen (CN); Guzheng Wu, Shenzhen (CN); Dong Wei, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/618,891

(22) Filed: Nov. 16, 2009

Related U.S. Application Data
(63) Continuation of application No. PCT/CN2008/070908, filed on May 8, 2009.

(30) Foreign Application Priority Data
May 15, 2007 (CN) 200710106256.0

(51) Int. Cl. G06F 15/177

(52) U.S. Cl. 709/222

(57) ABSTRACT

An operation method of peripheral device includes setting up connection of peripheral device to host, directly loading firmware of said peripheral device from said host, and operating said firmware by said peripheral device. The requirement of the peripheral device to non-volatile memory capacity is decreased. By pre-storing the firmware of the peripheral device in the host, the requirement of the peripheral device to non-volatile memory capacity is decreased. And it is not necessary to download the firmware in the non-volatile memory frequently when producing and debugging the peripheral device. Only loading the firmware of the peripheral device from the host directly is needed, and the efficiency is improved.

### CROSS-REFERENCE TO RELATED APPLICATIONS

This application is a continuation of International Application No. PCT/CN2008/070908, filed on May 8, 2008, which claims priority to Chinese Patent Application No. 200710106256.0, filed on May 15, 2007, both of which are hereby incorporated by reference in their entireties.

### FIELD OF THE INVENTION

The present invention relates to the field of electronic computer technology, and in particular to a peripheral device operation method.

### BACKGROUND OF THE INVENTION

Various consumption electronic products are emerging constantly along with popularization of personal computers and flourishing development of electronic technologies. These electronic products are typically interconnected and intercommunicate with personal computers and provide users with specific functions. These electronic products, with respect to personal computer system, can generally be referred to as peripheral devices, examples of which include digital cameras, digital video recorders, wireless network cards, wireless modems, printers, etc.

The above peripheral devices, according to their characteristic of usage, may be classified into two types, i.e. separately usable peripheral devices and cooperatively usable peripheral devices. The independently usable peripheral devices refer to peripheral devices which can be used independently and provide specific functions without being connected with any personal computers, e.g. digital cameras, etc. The cooperatively usable peripheral devices refer to peripheral devices which can provide specific functions only if they are connected with personal computers, e.g. wired modems, wireless network cards, wireless modems, etc.

For a computer, the work efficiency and reliability of its peripheral devices have significant influences on the operation of the entire computer system. Consequently, there would be higher requirements imposed on computer peripheral devices technologies and products performance.

Storage and operation process of firmware for an existing peripheral device is substantially the same regardless of whether a independently or cooperatively usable peripheral device, as shown in FIG. 1.

Firmware of a peripheral device is typically stored in a nonvolatile memory of the peripheral device, e.g. a Read Only Memory (ROM). When the peripheral device is powered on, the firmware is loaded from the ROM into a Random Access Memory (RAM) and then is executed normally in the RAM by a Central Processing Unit (CPU) in the peripheral device.

However, peripheral device systems become more complex as peripheral devices are increasingly functionally powerful. Therefore, there is an objective demand for larger capacities of nonvolatile memories for storage of firmware, e.g. ROMs, which thereby results in even higher manufacturing cost of the peripheral devices.

In addition, the firmware of the peripheral devices has to be frequently downloaded to the nonvolatile memory of the peripheral devices such as ROM before being executed in the RAM by the CPU of the peripheral devices during the manufacturing and debugging process of the peripheral devices, which may accordingly bring inconvenience to the manufacturing and debugging process of the peripheral devices.

### SUMMARY OF THE INVENTION

Embodiments of the invention provide a peripheral device operation method, a peripheral device and a host, so that the peripheral device has a lower requirement for the capacity of the nonvolatile memory.

An embodiment of the invention provides a peripheral device operation method including: establishing, by a peripheral device, a connection with a host; loading, directly from the host, firmware of the peripheral device; and operating, by the peripheral device, the firmware.

An embodiment of the invention provides a peripheral device, including:
a connecting unit configured to establish a connection with a host, to receive firmware of the peripheral device transmitted by the host, and forward the firmware of the peripheral device to a loading unit;
the loading unit configured to load the firmware of the peripheral device transmitted by the connecting unit; and
an operating unit configured to operate the firmware of the peripheral device;
in which the connecting unit, after establishing the connection with the host, instructs the loading unit to receive the firmware of the peripheral device: the loading unit receives and loads the firmware of the peripheral device; and the operating unit operates the firmware of the peripheral device after the loading unit completes loading of the firmware of the peripheral device.

An embodiment of the invention further provides a host, including:
a connecting unit configured to establish a connection with a peripheral device, to receive the firmware of the peripheral device transmitted by the loading unit, and forward the firmware of the peripheral device to the peripheral device; and
a loading unit configured to acquire and transmit to the connecting unit the firmware of the peripheral device after the connecting unit establishes the connection with the peripheral device.

According to the technical solution provided by the embodiments of the invention, the peripheral device establishes a connection with the host and loads directly from the host the firmware of the peripheral device, so that the peripheral device operates the firmware. Because it is not necessary for the firmware of the peripheral device to be stored into the nonvolatile memory of the peripheral device, the requirement for the capacity of the nonvolatile memory may be reduced, thereby saving the cost and promoting competitiveness of the product in the market. Meanwhile, it is not necessary to frequently download the firmware of the peripheral device to the nonvolatile memory of the peripheral device during manufacturing and debugging the peripheral device, but instead, the firmware of the peripheral device is loaded directly from the host, which improves the efficiency of manufacturing and debugging the peripheral device.

### BRIEF DESCRIPTION OF THE DRAWINGS

FIG. 1 illustrates a schematic diagram of storage and operation of firmware of a peripheral device in the conventional art;

FIG. 2 illustrates a flow chart of a peripheral device operation method according to the first embodiment of the invention;

FIG. 3 illustrates a schematic diagram of structures of a peripheral device according to the second embodiment of the present invention: and

FIG. 4 illustrates a schematic diagram of structures of a host according to the third embodiment of the present invention.

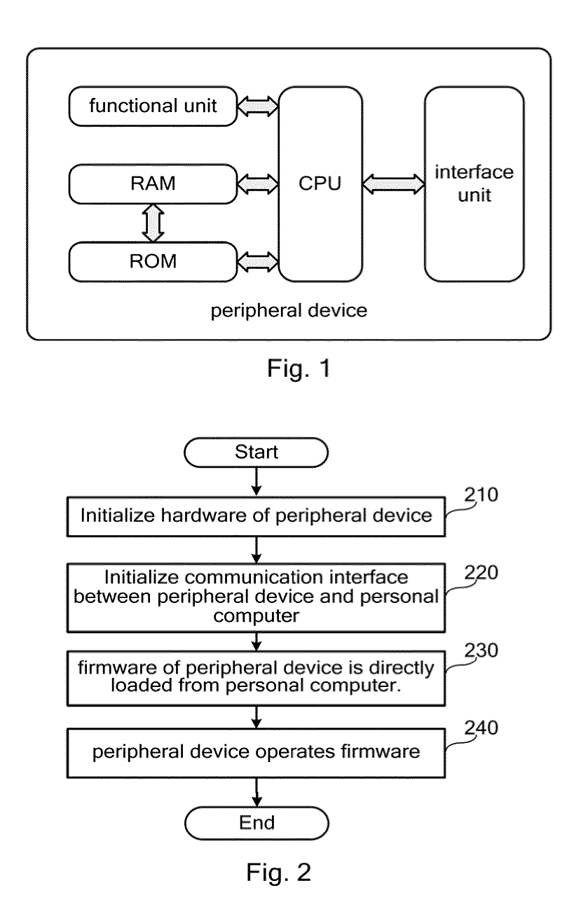

### DETAILED DESCRIPTION OF THE EMBODIMENTS

The embodiments of the invention are further described in detail below with reference to the drawings to make the objects, technical solution and advantages of the invention more apparent.

The first embodiment of the present invention relates to a peripheral device operation method. In this embodiment, only hardware initialization instructions and communication interface initialization instructions are stored in a nonvolatile memory of the peripheral device, and other firmware of the peripheral device is stored in a storage unit (e.g. a hard disk) of a host. The peripheral device in this embodiment is a peripheral device which needs to be connected with the host in order to cooperatively provide a specific function, e.g. a wireless data card, a wireless modem, and a wireless communication module, etc.

FIG. 2 illustrates a flow which will be described below by way of an example in which the host is a personal computer. The peripheral device operation method in this embodiment includes:

In Step 210, hardware of a peripheral device is initialized.

Specifically, the peripheral device, after being connected with the personal computer and powered on, will automatically load a hardware system initialization instruction stored in a ROM of the peripheral device, and thus complete status self-check and system configuration process of the hardware system of the peripheral device. This process is a necessary process for the peripheral device, and the initialization process of the hardware system varies from one peripheral device to another.

In step 220, a communication interface between the peripheral device and the personal computer is initialized. Specifically, the peripheral device, after completing the above hardware initialization process, will automatically load a initialization instruction of the communication interface stored in the ROM of the peripheral device, and the personal computer will also load a initialization instruction of the communication interface stored in the personal computer, thereby cooperatively completing the configuring process for a communication channel between the peripheral device and the personal computer, and implementing communication functions between the peripheral device and the personal computer.

In step 230, firmware of the peripheral device is directly loaded from the personal computer. The loading process of the firmware may either be initiated by the personal computer or be initiated by the peripheral device.

Specifically, the firmware of the peripheral device is generated in specific format by the manufacturer of the peripheral device, and may be provided through various possible approaches to a user (for example, the firmware of the peripheral device is recorded in an optical disk to be provided to the users), so that the user stores the firmware of the peripheral device into a storage unit of the personal computer. The personal computer, because of its enormous capacity of the storage unit and very low cost for usage, is particularly appropriate for storing the firmware of the peripheral device with relatively huge capacity.

After the peripheral device is connected with the personal computer and the above processes of hardware and communication interface initialization are completed, the peripheral device or the personal computer initiates the loading process for the firmware of the peripheral device. For example, the personal computer determines whether the firmware of the peripheral device matches the type of the peripheral device, and if so, executes the loading process for the firmware of the peripheral device, i.e. the personal computer transmits the firmware of the peripheral device to the peripheral device via the communication interface between the personal computer and the peripheral device; if the personal computer determines that the firmware of the peripheral device does not match the type of the peripheral device, the personal computer terminates the loading process for the firmware of the peripheral device.

No matter in the firmware loading process initiated by the peripheral device or in the firmware loading process initiated by the personal computer, the firmware of the peripheral device will be directly loaded from the personal computer into the RAM of the peripheral device, which is similar to the current process in which firmware is loaded from a ROM to a RAM when the peripheral device starts up.

In step 240, the peripheral device operates the firmware, i.e. a central processing unit of the peripheral device executes the firmware instructions of the peripheral device stored in the RAM. Specifically, after the firmware of the peripheral device is directly loaded to the RAM of the peripheral device from the personal computer, a program pointer of the peripheral device points to a specific position in the RAM, so as to start operating the firmware of the peripheral device properly in the RAM, thereby implementing the specific function of the peripheral device.

In this embodiment, because it is not necessary for the firmware of the peripheral device to be stored in the nonvolatile memory of the peripheral device, the requirement by the peripheral device for the capacity of the nonvolatile memory may be significantly reduced, thereby saving the cost and promoting competitiveness of the product in the market. Meanwhile, it is not necessary to frequently download the firmware of the peripheral device to the nonvolatile memory of the peripheral device during manufacturing and debugging the peripheral device, but instead, the firmware of the peripheral device is loaded directly from the host, which improves the efficiency of manufacturing and debugging the peripheral device. Further, because the firmware of the peripheral device is stored in the host and it is easier to update the firmware in the host than in the peripheral device, therefore, the peripheral device can be updated conveniently.

It is noted that although this embodiment has been described with personal computer as an example, the host will not be limited to the personal computer but may also include a personal digital assistant (PDA), a server, etc.

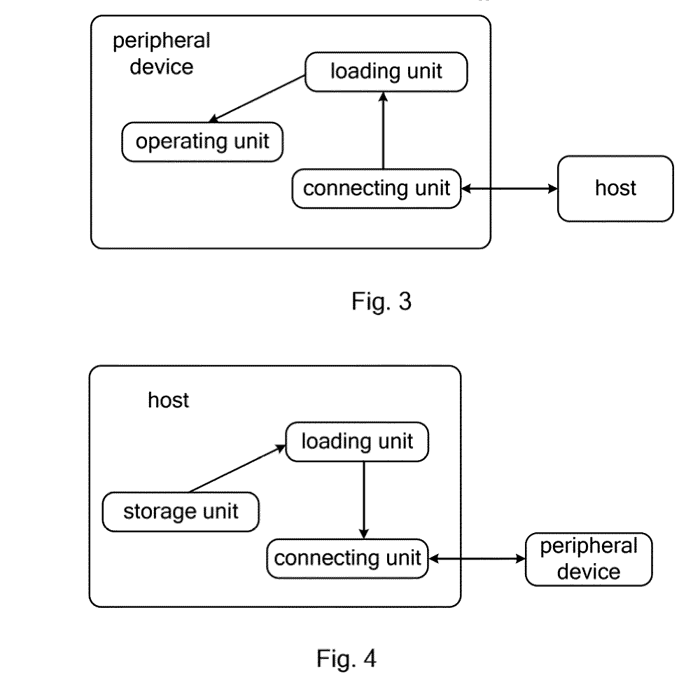

The second embodiment of the invention relates to a peripheral device as illustrated in FIG. 3. The peripheral device includes:
a connecting unit configured to establish a connection with a host (e.g. a personal computer), to receive firmware of the peripheral device transmitted by the host, and forward the firmware of the peripheral device to a loading unit;
a loading unit configured to receive and load the firmware of the peripheral device transmitted by the connecting unit, i.e. configured to write directly the received firmware of the peripheral device into a RAM of the peripheral device;
an executing unit configured to execute the firmware of the peripheral device, i.e. configured to execute firmware instruction of the peripheral device stored in a RAM of the peripheral device by a central processing unit of the peripheral device.

The connecting unit, after establishing the connection with the host, instructs the loading unit to receive the firmware of the peripheral device; the loading unit receives and loads the firmware of the peripheral device; and the operating unit operates the firmware of the peripheral device after the loading unit finishes loading the firmware of the peripheral device.

Specifically, the connecting unit includes the following sub-units configured to establish the connection with the host: hardware initializing sub-unit configured to initialize hardware of the peripheral device; communication interface initializing sub-unit configured to initialize the communication interface between the peripheral device and the host. The peripheral device in this embodiment can be a peripheral device in cooperative use with a computer, e.g. a wireless data card, a wireless modem, a wireless communication module.

Because the firmware of the peripheral device is stored in the storage unit of the personal computer instead of the nonvolatile memory of the peripheral device, the requirement by the peripheral device for the capacity of the nonvolatile memory may be significantly reduced, thereby saving the cost and promoting competitiveness of the peripheral device in the market. Moreover, it is not necessary to download the firmware of the peripheral device to the nonvolatile memory of the peripheral device during manufacturing and debugging the peripheral device, but instead, the firmware of the peripheral device is loaded directly from the host, thereby improving the efficiency of manufacturing and debugging the peripheral device.

The third embodiment of the invention relates to a host as illustrated in FIG. 4. The host includes:
a storage unit configured to store firmware of a peripheral device;
a connecting unit configured to establish a connection with the peripheral device, receive the firmware of the peripheral device transmitted by a loading unit, and forward the firmware of the peripheral device to the peripheral device;
a loading unit configured to acquire the firmware of the peripheral device from the storage unit and transmit the acquired firmware of the peripheral device to the connecting unit after the connecting unit establishes the connection with the peripheral device, thereby the connecting unit forwards the firmware of the peripheral device to the peripheral device, which significantly reduces the requirement by the peripheral device for the capacity of the nonvolatile memory (such as ROM), thereby saving the cost and promoting competitiveness of the peripheral device in the market.

In practical applications, the host of this embodiment may be a personal computer.

It should be noted that the units described in the second and the third embodiments are all logical units which, in physical implementations, may be implemented in a single physical module or in several different physical modules, and which may be a processor or a logical circuit (including programmable logical circuit), and also may be an instruction set operating on a processor that can realize corresponding functions. For example, in the second embodiment, the operating unit and the loading unit may be integrated into a single processor such as a digital signal processor (i.e. “DSP”) whereas the connecting unit may be a programmable logical circuit.

As a conclusion, in the embodiments of the present invention, the peripheral device establishes a connection with the host and loads directly from the host the firmware of the peripheral device, so that the peripheral device operates the firmware. Because it may be not necessary for the firmware of the peripheral device to be stored in the nonvolatile memory of the peripheral device, the requirement by the peripheral device for the capacity of the nonvolatile memory may be significantly reduced, thereby saving the cost and promoting competitiveness of the product in the market. Meanwhile, it is not necessary to frequently download the firmware of the peripheral device to the nonvolatile memory of the peripheral device during manufacturing and debugging the peripheral device, but instead, the firmware of the peripheral device is loaded directly from the host, which improves the efficiency of manufacturing and debugging the peripheral device.

Because the firmware of the peripheral device is stored in the host and it is easier to update the firmware in the host than in the peripheral device, therefore, the peripheral device can be updated conveniently.

Although the invention has been illustrated and described with reference to some preferred embodiments of the invention, those ordinarily skilled in the art shall understand that the invention can be modified variously in the forms and details thereof without departing from the spirit and scope of the invention.

What is claimed is:

1. A peripheral device operation method, comprising:
establishing, by a peripheral device, a connection with a host;
loading, directly from the host, firmware of the peripheral device; and
operating, by the peripheral device, the firmware.

2. The method according to claim 1, wherein before process of the peripheral device establishing the connection with the host, the method further comprises:
pre-storing the firmware of the peripheral device in the host.

3. The method according to claim 1, wherein the process of loading directly from the host the firmware of the peripheral device comprises:
acquiring, from the host, the pre-stored firmware of the peripheral device;
writing directly the acquired firmware of the peripheral device into a random access memory of the peripheral device.

4. The method according to claim 1, wherein the process of the peripheral device establishing the connection with the host comprises:
initializing hardware of the peripheral device; and initializing a communication interface between the peripheral device and the host.

5. The method according to claim 4, wherein an initialization instruction for the hardware is stored in the peripheral device;
an initialization instruction for the communication interface is stored respectively in the peripheral device and in the host.

6. A peripheral device, comprising:
a connecting unit configured to establish a connection with a host, to receive firmware of the peripheral device transmitted by the host, and forward the firmware of the peripheral device to a loading unit;
the loading unit configured to load the firmware of the peripheral device transmitted by the connecting unit;
an operating unit configured to operate the firmware of the peripheral device:
wherein the connecting unit, after establishing the connection with the host, instructs the loading unit to receive the firmware of the peripheral device; the loading unit receives and loads the firmware of the peripheral device; and the operating unit operates the firmware of the peripheral device after the loading unit completes loading of the firmware of the peripheral device.

7. The device according to claim 6, wherein the loading unit loads the firmware of the peripheral device in the following manner of:
writing directly the firmware of the peripheral device received from the connecting unit into a random access memory of the peripheral device.

8. The device according to claim 7, wherein the operating unit operates the firmware of the peripheral device in the following way of:
executing, by a central processing unit of the peripheral device, firmware instructions of the peripheral device stored in the random access memory of the peripheral device.

9. The device according to claim 6, wherein the peripheral device is:
a wireless data card, a wireless modem, or a wireless communication module.

10. A host, comprising:
a connecting unit configured to establish a connection with a peripheral device, to receive firmware of the peripheral device transmitted by the loading unit, and forward the firmware of the peripheral device to the peripheral device; and
a loading unit configured to acquire and transmit to the connecting unit the firmware of the peripheral device after the connecting unit establishes the connection with the peripheral device.

11. The host according to claim 10, further comprising:
a storage unit configured to store the firmware of the peripheral device;
wherein the loading unit acquires the firmware of the peripheral device from the storage unit.

12. The host according to claim 10, wherein the host is a personal computer.
